(19) United States
(12) Patent Application Publication
(10) Pub. No.: US 2013/0132993 A1
(43) Pub. Date: May 23, 2013

(54) TRACKING LOCAL TELEPHONE NUMBERS

(71) Applicants: Jill A. Huchital, Saratoga, CA (US); Rohit Dhawan, San Francisco, CA (US)

(72) Inventors: Jill A. Huchital, Saratoga, CA (US); Rohit Dhawan, San Francisco, CA (US)

(73) Assignee: GOOGLE INC., Mountain View, CA (US)

(21) Appl. No.: 11/780,389

(22) Filed: Jul. 19, 2007

(51) Int. Cl. H04H 9/00

(52) U.S. Cl. 725/22

(57) ABSTRACT

The present disclosure includes a system and method for tracking local telephone numbers. In some implementations, a method of tracking local TV ads includes receiving tracking information for a TV advertisement from a plurality of geographic regions. The TV advertisement are presented in each geographic region with a local telephone number. Metrics associated with the TV advertisement are determined for each geographic region using the tracking information. One or more Web pages are populated with at least one or more metrics for presenting to an advertiser.

### TECHNICAL FIELD

This invention relates to advertising.

### BACKGROUND

Broadcasted content can provide information associated with goods and/or services. For example, the broadcasted content may present information associated goods, services, news, games, entertainment, music, books, online content, and others. Advertisers sometimes track viewers' responses to the broadcasted content to determine associated metrics and/or modify these goods and/or services based on such interactions to further enhance the viewer experience.

### SUMMARY

The present disclosure includes a system and method for tracking local telephone numbers. In some implementations, a method of tracking local TV ads includes receiving tracking information for a TV advertisement from a plurality of geographic regions. The TV advertisement is presented in each geographic region with a local telephone number. Metrics associated with the TV advertisement are determined for each geographic region using the tracking information. One or more Web pages are populated with at least one or more metrics for presenting to an advertiser.

The details of one or more embodiments of the invention are set forth in the accompanying drawings and the description below. Other features, objects, and advantages of the invention will he apparent from the description and drawings, and from the claims.

### DESCRIPTION OF DRAWINGS

FIG. 1 is a block diagram illustrating an example system for identifying responses to television advertisements in accordance with some implementations of the present disclosure;

FIG. 2 is a block diagram illustrating an example tracking system of FIG. 1 in accordance with, some implementations of the present disclosure;

FIG. 3 is a flow chart illustrating an example method for tracking responses to television advertisements;

FIG. 4 is a flow chart illustrating another example method for tracking responses to television advertisements;

FIG. 5 is a flow chart illustrating an example method for associating a television advertisements with telephone numbers;

FIG. 6 is a flow chart illustrating another example method for associating a television advertisements with telephone numbers;

FIG. 7 is a block diagram illustrating an example system for associating television advertisements with telephone numbers; and

FIG. 8 is flow chart illustrating an example method for embedding telephone numbers in television advertisements.

Like reference symbols in the various drawings indicate like elements.

### DETAILED DESCRIPTION

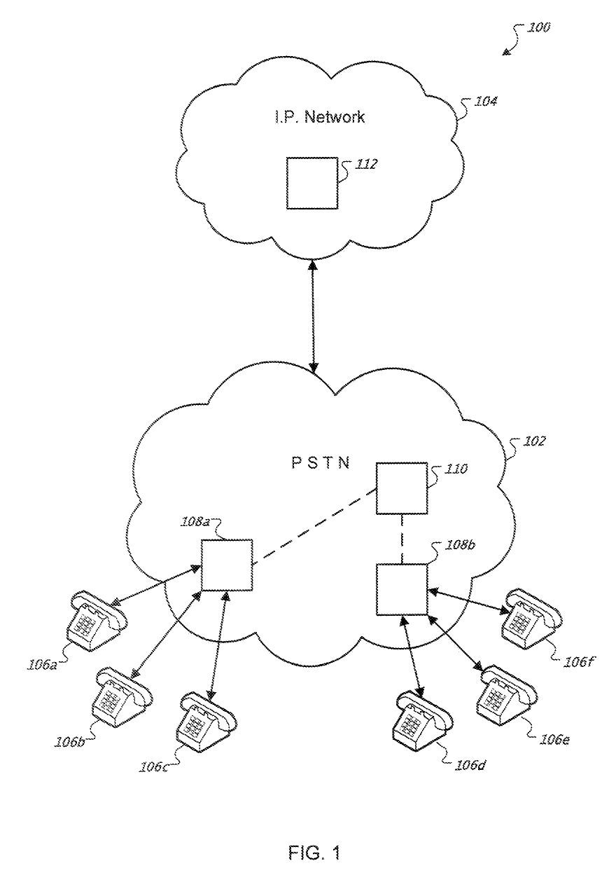

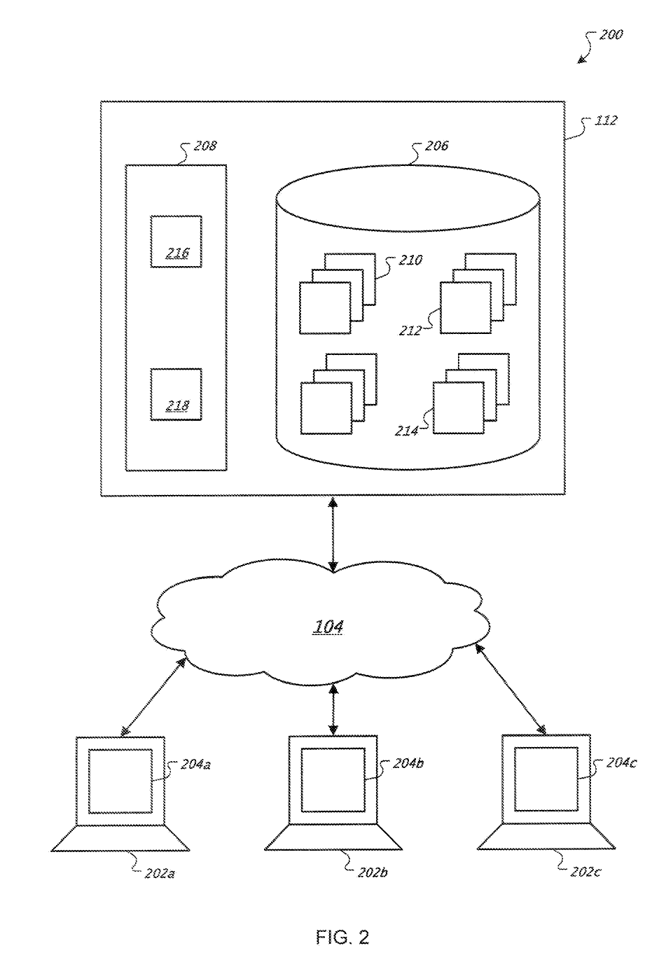

FIG. 1 illustrates a system 100 for identifying responses to television advertisements presented in a geographic location. A geographic location may comprise a county, a city, a state, and/or other physical locations. For example, the system 100 may assign or otherwise associate one or more phone numbers with the presentation of a television advertisement (“TV ad”) in a geographic location and identify responses to the TV ad in the geographic location based, at least in part, on the phone numbers. In some implementations, advertisers select and/or modify geographic locations associated with the television advertisements. In this case, the advertiser can specific the geographic locations within which responses are tracked. In addition, the advertiser can, in some implementations, assign specific phone numbers to the tracked geographic locations. In some implementations, the system 100 may associated a plurality of phone numbers to a geographic region. In some implementations, the system 100 may associate a phone number assigned to the geographic location (“local number”) to a TV ad. In this implementation, the local number may have an area code assigned to the geographic location. Alternatively or in combination, the local number may include digits associated with one or more geographic locations within a specific area code. In the case that the system 100 is implemented in a country that does not rely on area codes, the system 100 may use other processes for associating phone numbers to geographic locations. In some implementations, the geographic location may comprise a single contiguous region, a plurality of regions that are not contiguous or any other region defined by, for example, an advertiser. In some implementations, the defined geographic location may not align with an area code, city, state, or other boundaries previously defined by another entity. In directing calls to the assigned phone number (e.g., a call number), the system 100 may identify responses to TV ads presented within the geographic location. In addition, the system 100 may track responses to these advertisements as discussed with respect to FIG. 2.

As for a high level description of the elements, the system 100, in some implementations, includes a public switched telephone network (PSTN) 102 couple to an Internet Protocol (IP) network 104 and telephone devices 106. The PSTN 102 includes switching elements 108 for identifying tracking information from calls received from telephone devices 106 and directing these calls to associated advertisers 110. The IP network 104 includes a tracking server 112 for evaluating tracking information associated with ads displayed with one or more geographic regions. Turning to a high level description of the operation, the telephone devices 106 initiate calls in response to a local advertisement displaying a local phone number. The switching element 108 associated with at least one geographic region identifies tracking information included in the initiation request and routes the call request to the associated advertiser 110. In addition, the switching element 108 can transmit tracking information to the tracking server 112 for evaluation.

As for a more detailed description of the illustrated elements, the PSTN 102 is used for communicating via telephone land lines. The PSTN 102 is a circuit-switched telephone network which may be used for land line voice calls, digital subscriber line (DSL) internet access, and/or dial-up modem internet access. A set of access tandem and end office switches segment the network into sections which are considered to be within a local calling distance. For example, communications relayed through the PSTN 102 can be sent from a local user via an end office switch, through a series of access tandem switches, and through the remote end office switch to a remote user. In transmitting signals, PSTN 102 may use one or more of the following: telephones, key telephone systems, private branch exchange trunks, and certain data arrangements. Since PSTN 102 may be a collection of different telephone networks, portions of PSTN 102 may use different transmission media and/or compression techniques. Completion of a circuit in PSTN 102 between a call originator and a call receiver may require network signaling in the form of either dial pulses or multi-frequency tones. In the illustrated implementation, the PSTN 102 includes telephone devices 106a-f, switching elements 108, and advertiser 110. Telephone devices 106a-f comprise any telecommunication device operable to electronically receive and transmit sound. Generally, a telephone device operates through transmission of electric signals over the PSTN 102 to allow users to communicate. The system 100 may include other communication devices (not illustrated) such as cellular phones, IP phones, softphones, and/or others. In some implementation, phone numbers provided by TV ads direct call initiation requests from the telephone device 106 to the switching element 108.

The switching element 108 comprises any hardware, software, and/or firmware operable to route calls between devices in the PSTN 102. For example, the switching element 108 may receive a request to initiate a call from the telephone device 106 and based, at least in part, on the request route the call to another element in the PSTN 102. In some implementations, the switching element 108 may perform one or more of the following functions: receive a request to initiate a call, identify a destination device using the request, map the request to one or more destination devices, route the call request to the identified devices, and/or transmit tracking information to the IP network 104. In regards to mapping a phone number (e.g., local number) to a destination device, the switching element 108 may include instructions, algorithms, or other directives for mapping a phone number displayed in a TV ad to an associated advertiser 110. For example, the switching element 108 may receive a request to initiate a call that identifies a telephone number presented in a TV ad and, in response to at least the request, automatically map the number to a number associated with the advertiser 110. In some implementations, the switching element 108 is associated with one or more geographic regions such that received call requests are automatically identified as originating from the one or more geographic regions. In connection with identifying the advertiser 110, the switching element 108 may route, switch or otherwise transmit the call initiate request to the advertiser 110. In addition, the switching element 108 may transmit information associated with the request to the IP network 104 for tracking responses to TV ads. For example, the switching element 108 may transmit information identifying one or more of the following: the advertised number, the time, the date, the geographic location, and/or other information associated with the TV ad and/or user of the device 106.

The advertiser 110 can be any hardware, software, and/or firmware that manages calls associated with an advertiser. For example, the advertiser 110 may receive a request for products and/or services displayed through a TV ad. In general, the advertiser 110 may perform one or more of the following functions: receive requests to initiate calls, route the request to a telephone and/or call center of the advertiser, provide access to automated call services, and/or others. In some implementation, the advertiser 110 is controlled, managed, or otherwise associated with a particular advertiser. In some implementations, the advertiser 110 may be managed by a third party. The advertiser 110 may be a call center, an automated system, a switch for routing calls to telephones, and/or other device or system for receiving calls associated with an advertiser.

As mentioned above, the switching element 108 may transmit information associated with a call request to the IP network 104. Network 104 facilitates wireless or wireline communication between a tracking server 112 (see FIG. 2) and any other local or remote computer, such as the switching elements 108. Network 104 may be all or a portion of an enterprise or secured network. While illustrated as single network, network 104 may be a continuous network logically divided into various sub-nets or virtual networks without departing from the scope of this disclosure, so long as at least a portion of network 104 may facilitate communications of tracking information between the tracking server 112 and at least one switching element 108. In some implementations, network 104 encompasses any internal or external network, networks, sub-network, or combination thereof operable to facilitate communications between various computing components in system 100. While network 104 communicates Internet Protocol (IP) packets, the network 104 may comprises other types of networks that transmit, for example, Frame Relay frames, Asynchronous Transfer Mode (ATM) cells, voice, video, data, and other information between requested addresses. Network 104 may include one or more local area networks (LANs), radio access networks (RANs), metropolitan area, networks (MANs), wide area networks (WANs), all or a portion of the global computer network known as the Internet, and/or any other communication system, or systems at one or more locations.

In one aspect of operation, a telephone device 106 initiates a call request in response to the presentation of a local TV ad. In particular, the telephone device 106 transmits a call request using a local phone number displayed with the local TV ad. The PSTN 102 routes the call request to the switching element 108. Using the call request, the switching element 108 identifies tracking information, such as geographic region, advertiser ID, caller ID, and/or other information, and transmits this information to the tracking sewer 112. In addition, the switching element 108 redirects the call request to the associated advertiser 110. The advertiser 110 establishes a call session with the telephone device 106 through the PSTN 102 to provide information associated with the advertised goods and/or services.

FIG. 2 is an example tracking system 200 for evaluating responses to local TV ads in accordance with some implementations of the present disclosure. For example, the tracking system 200 may track actions associated with TV ads displayed in one or more geographic regions. Actions may include one or more of the following: a call, a purchase, an inquiry, answering a questionnaire, and/or other actions associated with a TV ad. In some implementations, the system 200 performs one or more of the following functions: determines likelihoods that actions are in response to local TV ads, evaluate effectiveness of TV ads in different geographic locations (e.g., action rates), and/or presents information associated with evaluating responses to users (e.g., advertiser) of the system 200. For example, the system 200 may associate likelihoods that purchases are in response to a local TV ad based, at least in part, on a time period between the purchase and presentation of the local ad. In regards to determining effectiveness in a geographic location, the system 200 may determine, for example, how-many actions are performed per presentation of a TV ad within the geographic location.

At a high level, the system 200, in some implementations, includes clients 202 coupled to tracking server 112 through the network 104. In this implementation, a client 202 includes a Graphical User Interface (GUT) 204 for displaying displays 210 provided by the tracking server 112. The tracking server 112 includes a memory 206 and a processor 208. In some implementations, the memory 206 locally stores the displays 210, tracking files 212 for storing tracking information, evaluation criteria 214 for evaluating tracking information. The processor 120 includes a request engine 216 for processing requests received from the network 104 (e.g., client 202) and an evaluation engine 218 for evaluating tracking files 212 using evaluation criteria 214. Turning to a high level description of the operation of the illustrated tracking system 200, the client 202 transmits a request to the tracking server 112 for a display 210 for display through the GUI 204. In some implementations, the request may identify a specific display for presenting reports that include evaluated tracking information. In some implementations, the request is for a dynamically generated display 210. For example, the user may request tracking information and, in response to the request, the tracking server 112 may dynamically generate a display 210 based, at least in part, on requested information. In response to at least the request, the tracking server 112 identifies the display 210 and transmits the identified display 210 to the client 202 through the network 104 for display through the GUI 204. In addition, the evaluation engine 218 may evaluate one or more tracking files 212 in response to an event. For example, the event may he the expiration of a period of time, a request, a certain number of actions associated with a TV ad, and/or other event. In some implementations, the evaluation engine 218 identifies evaluation criteria 214 and, using the identified criteria 214, evaluates one or more tracking files 212.

As for a more detailed description of the illustrated elements, the client 202 includes or executes at least GUI 204 and comprises an electronic device (e.g., a computing device) operable to receive, transmit, process and store data associated with the system 100. While not illustrated, the system 100 may include any number of clients 102 communicably coupled to the tracking server 112. Further, “client 202” and “user” may be used interchangeably as appropriate without departing from the scope of this disclosure. Moreover, for ease of illustration, the client 202 is described in terms of being used by one user, but many users may use one device (e.g., client 202) or that one user may use multiple devices without departing from the scope of this disclosure.

As used in this disclosure, the client 202 is any person, department, organization, small business, enterprise, or any other entity that may use or request others to use the system 100. The client 202 is intended to encompass a personal computer, touch screen terminal, workstation, network computer, kiosk, wireless data port, smart phone, personal data assistant (PDA), cellular device, one or more processors within these or other devices, or any other suitable electronic device used by a user viewing displays 210 from the tracking server 112. For example, the client 202 may be a PDA operable to wirelessly connect with an external or unsecured network. In another example, the client 202 may comprise a laptop that includes an input device, such as a keypad, touch screen, mouse, or other device that can accept information, and an output device that conveys information from the tracking server 112 (e.g., evaluation reports), including digital data, visual information, or the GUI 204. Both the input device and output device may include fixed or removable storage media such as a magnetic computer disk, CD-ROM, or other suitable media to both receive input from and provide output to users of the client 202 through the display, namely the client portion of the GUI 204.

The GUI 204 comprises a graphical user interface operable to allow the user of the client 202 to interface with at least a portion of the system 200 for any suitable purpose, such as viewing displays 210. Generally, the GUI 204 provides the particular user with an efficient and user-friendly presentation of data provided by or communicated within the system 200. The GUI 204 may comprise a plurality of customizable frames or views having interactive fields, pull-down lists, and/or buttons operated by the user. For example, the GUI 204 is operable to display certain links 116 in a user-friendly form based on the user context and the displayed data. The term graphical user interface may be used in the singular or in the plural to describe one or more graphical user interfaces and each of the displays of a particular graphical user interface. The GUI 204 contemplates any graphical user interface, such as a generic web browser or touch screen, that processes information in the system 200 and presents the results to the user. The tracking server 112 can accept data from the client 202 using, for example, the web browser (e.g., Microsoft Internet Explorer or Mozilla Firefox) and return the appropriate responses (e.g., HTML or XML) to the browser using the network 104.

The tracking server 112 comprises an electronic computing device operable to receive, transmit, process and store data associated with system 200. The system 200 can be implemented using computers other than servers, as well as a server pool. Indeed, tracking server 112 may be any computer, electronic or processing device such as, for example, a blade server, general-purpose personal computer (PC), Macintosh, workstation, Unix-based computer, or any other suitable device. In other words, the system 200 may include computers other than general purpose computers as well as computers without conventional operating systems. The tracking server 112 may be adapted to execute any operating system including Linux, UNIX, Windows Server, or any other suitable operating system. In certain implementations, the tracking server 112 may also include or be communicably coupled with a web server and/or a mail server.

The tracking server 112 includes memory 206 and a processor 208. Memory 206 may be a local memory and include any memory or database module and may take the form of volatile or non-volatile memory including, without limitation, magnetic media, optical media, random access memory (RAM), read-only memory (ROM), removable media, or any other suitable local or remote memory component. In the illustrated implementation, memory 206 includes displays 210, tracking files 212, and evaluation criteria 214. Displays 210 comprise displays through which information associated with the production and/or the distribution of ads can be presented to users of clients 102. In general, displays 210 include any machine readable and machine storable work product that may generate or be used to generate a display through GUI 204. Displays 210 may be a file, a combination of files, one or more files with embedded links to other files, or any other suitable configuration. Displays 210 may include text, audio, image, video, animation, and other attributes. In short, displays 210 comprise any source code or object code for generating a display that provides information for enabling users to perform, one or more functions of the ad tracking process. Display 210 may be written in or based on any suitable programming language such as HTML. In some implementations, the displays 210 Include one or more entries or data structures that identify or include information that identifies evaluation results. For example, the displays 210 may identify a summary of actions associated with a local TV ad presented in a specific geographic location. In some implementations, the displays 210 includes a total number of purchases associated with a specific instance of the local TV ad. In some implementations, the displays 210 may include purchase rates associated with the local TV ad. The information included in the displays 210 may be based on any appropriate parameter such as period of time, geographic location, demographics, and/or other values. In summary, the displays 210 may include one or more of the following: number of actions, type of action, instance of the TV ad, response time, date, time, and/or other information.

The tracking files 212 include one or more data structures or entries that identify or include information that identifies actions associated with one or more TV ads. For example, one or more tracking files 212 may include or identify actions associated with a presented TV ad such as purchases. While tracking files 212 are illustrated as files residing on the server 112, the tracking files 212, in some implementations, can comprise a database. In some implementations, the tracking files 212 may identify or include information that identifies one or more of the following parameters: instances of presentation, geographic locations, dates, times, actions (e.g., purchases, inquiries), duration of call, telephone number detailed, telephone number forwarded to, user, client, an advertiser, and/or others. The tracking file 212 may be associated with a specific instance of a local TV ad, multiple presentations of a local TV ad, a geographic location, multiple geographic locations, or multiple tracking files 212 may be associated with a single TV ad and/or a single geographic location. In some implementation, the association may be based on a parameter such as geographic locations. For example, a first tracking file 212 may be associated with a first geographic region and a second tracking file 212 may be associated with a second geographic region. In some implementations, the tracking files 212 may be formatted, stored, or defined as various data structures in text files, XML documents, VSAM files, flat tiles, Btrieve files, CSV files, internal variables, or one or more libraries. In short, the tracking files 212 may comprise one table or file or a plurality of tables or files stored on one computer or across a plurality of computers in any appropriate format. Moreover, the tracking files 212 may be local or remote without departing from the scope of this disclosure and store any type of appropriate data.

Evaluation criteria 214 include any parameters, variables, algorithms, instructions, rules, objects or other directives for evaluating local TV ads. For example, the evaluation criteria 214 may be used to determine action rates associated with the local TV ads. As mentioned above, such actions may include one or more of the following: conversions (e.g., purchases), calls received, inquiries, response time, and/or others. In some implementations, evaluation criteria 214 may include mathematical expressions for computing results (e.g., action rates) of the TV ad based on associated actions, criteria for evaluating the results (e.g., geographic location), and/or modifications to one or more tracking files 212. In terms of computing results, evaluation criteria 214 may identify expressions to determine action rates associated with the presented TV ad. Using such results, the evaluation criteria 214 may define criteria such as a logical expression for evaluating the TV ad for, in some implementations, a specific geographic location. For example, the criteria 214 may be used to determine a range that the conversion rates fall within. In this case, each range may be associated with a likelihood of conversion. Alternatively or in combination, the evaluation criteria 214 may identify expressions to determine probabilities that an action is associated with a presentation of a TV ad.

Processor 208 executes instructions and manipulates data to perform operations of the tracking server 112. Although FIG. 2 illustrates a single processor 208 in the server 112, multiple processors 208 may be used according to particular needs, and reference to processor 208 is meant to include multiple processors 208 where applicable. In the illustrated implementation, the processor 208 executes request engine 216 and an evaluation engine 218. The request engine 216 can be of the form of software, for example, operable to manage requests for information associated with presented TV ads. For example, the request engine 216 may identify one or more displays 210 in accordance with the request, in some implementations, the request engine 216 may perform one or more of the following: receive a request for tracking information from client 202, generate and/or update a request display 210 in accordance with information received from the client 202, and/or other functions associated with the tracking of a TV ad. In some implementations, the request engine 216 dynamically generates a display 210 based on one or more parameters. In this case, the request engine 216 may populate the generated display 210 with information included or otherwise associated with one or more tracking riles 212.

Evaluation engine 218 can include any routine (e.g., software) operable to determine and/or evaluate metrics associated with TV ads based on any suitable parameters. For example, the evaluation engine 218 may determine actions associated with TV ads presented in a geographic location. In some implementations, the evaluation engine 218 may determine action rates for one or more geographic locations using the tracking files 212. In the case of evaluating a TV ad, the evaluation engine 218 may identify tracking files 212 associated with the TV ad, evaluate the identified tracking files 212 using the evaluation criteria 214, and determine at least one metric associated with the TV ad. In some implementations, prior to evaluating responses, evaluation engine 218 may determine one or more likelihoods that the actions are associated with the presentation of the TV ad using evaluation criteria 214 and/or tracking files 212. In addition, the evaluation engine 218 may determine an action rate for a TV ad using the tracking files 212. For instance, if the TV ad was presented 5 times in a geographic location with 100 purchases associated with the TV ad, the conversion rate is 20 purchases per impression in the specific geographic location. Regardless of calculations, the evaluation engine 218 may identify criteria for evaluating the TV ad using evaluation criteria 214. Criteria may include a number, a range, a threshold, and/or any other suitable criteria for evaluating the TV ad. In some implementations, the evaluation engine 218 may compare associated actions and/or action rates and the criteria using any suitable mathematical and/or logical expression. For example, the evaluation engine 218 may determine or otherwise identify ranges associated with the presented ad using the evaluations criteria 214. For example, the evaluation engine 218 may identify 10 ranges associated with the TV ad. In response to satisfying a criterion, the evaluation engine 218 may associate a level (e.g., a likelihood) with the identified action.

Regardless of the particular implementation, “software” may include software, firmware, wired or programmed hardware, or any combination thereof as appropriate. Indeed, element engine 216 and evaluation engine 218 may be written or described in any appropriate computer language including C, C++, Java, J#, Visual Basic, assembler, Perl. PHP, as well as others. It will be understood that while the request engine 216 and the evaluation engine 218 are illustrated in FIG. 2 as including individual modules, the request engine 216 and/or the evaluation engine 218 may include numerous other sub-modules or may instead be a single multi-tasked module that implements the various features and functionality through various objects, methods, or other processes. Further, while illustrated as internal to the tracking server 112, one or more processes associated with the request engine 216 and/or the evaluation engine 218 may be stored, referenced, or executed remotely. Moreover, the request engine 216 and/or the evaluation engine 218 may be a child or sub-module of another software module or enterprise application (not illustrated) without departing from the scope of this disclosure.

In one aspect of operation, the request engine 216, in response to an event, identifies and/or generates one or more displays 210 for displaying information associated with local TV ads. In connection with the displays 210, the evaluation engine 218 may identify tracking riles 212 associated with a TV ad. In some implementations, the evaluation engine 218 may identify tracking files 212 associated with geographic regions that presented the TV ad. Using the evaluation criteria 214, the evaluation engine 218 determines one or more metrics associated with the geographic regions. The evaluation engine 218 may populate the displays 210 with the metrics and/or tracking information.

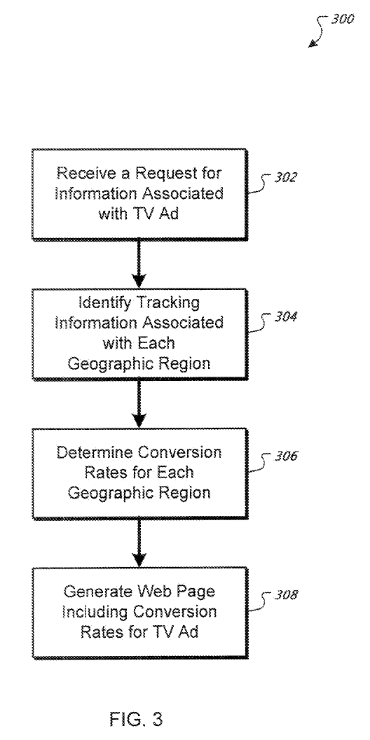

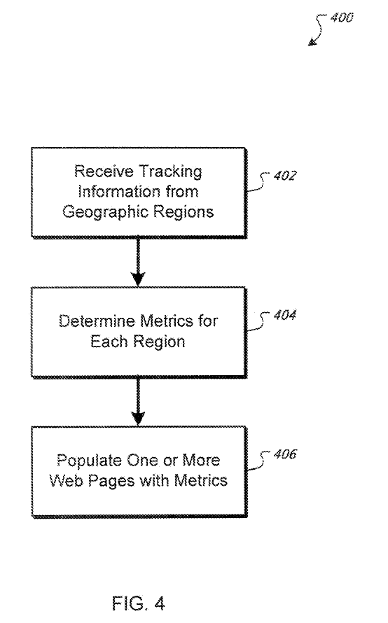

FIGS. 3 and 4 are flowcharts illustrating example methods 300 and 400, respectively, for evaluating tracking information associated with local TV ads. Method 300 describes an example technique for determining metrics for TV ads presented in specific geographic locations. Method 400 describes an example technique for generating Web pages including metrics associated with local TV ads. By way of example, methods 300 and 400 can be executed by system 200 using any appropriate combination and arrangement of logical elements implementing some or all of the described functionality.

Referring to FIG. 3, method 300 begins at step 302 where a request for information associated with a TV ad is received. For example, the requested information can include metrics associated with each geographic region that the TV ad was presented. At step 304, tracking information associated with each requested region is identified. As discussed above, the tracking information for each region may include the number of calls initiated, the number of conversions, and/or other information. Next, at step 306, conversion rates for each geographic regions is determined. For example, the TV ad may have been displayed in a first region 10 times resulting in 100 purchases and in a second region 2 times resulting in a 1000 purchase, so the conversion rate for the first region is 10 sales per presentation and the second region is 500 sales per presentation. At step 308, one or more Web pages are populated with the conversion rates and/or tracking information for display by the advertiser.

Referring to FIG. 4, method 400 begins with step 402 where tracking information for a TV ad is received from a plurality of geographic regions. At step 404, metrics for the TV ad is determined for each geographic region. For example, the total number of calls and/or transactions can be determined for each geographic in which the TV ad was broadcast. In connection with evaluating tracking information, the metrics may be stored in one or more files or databases. Next, at step 406, one or more Web pages are populated with the metrics to present the results of presenting the ads in the geographic regions. The Web pages may be generated in response to a request, and populated with stored evaluation information.

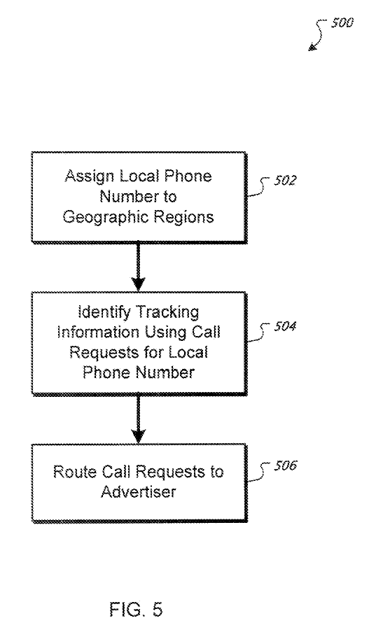

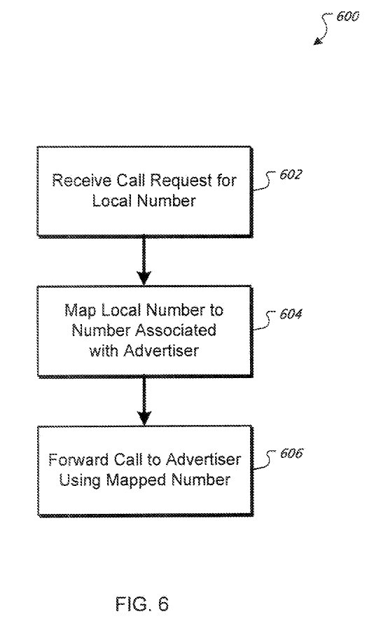

FIGS. 5 and 6 are flowcharts illustrating example methods 500 and 600, respectively, for tracking responses to local TV ads. Methods 500 and 600 generally describe using local telephone numbers for identifying tracking information using call initiation requests. By way of example, methods 500 and 600 can be executed by system 100 using any appropriate combination and arrangement of logical elements implementing some or all of the described functionality.

Referring to FIG. 5, method 500 begins at step 502 where local telephone numbers are assigned to associated geographic regions. As mentioned above, the association may be based on the area code of the local phone number. At step 504, tracking information is identified using call initiation request for the assigned local phone numbers. For example, the switching element 108 may receive call request for the local numbers from devices 106. Next, at step 506, the call request are routed to the advertiser after the tracking information is identified.

Referring to FIG. 6, method 600 begins at step 602 where a call request for a local telephone number associated with a local TV ad is received. At step 604, the local telephone number is mapped to a number associated with an advertiser. For example, the switch element 108 can map the local telephone number to a number for the advertiser. Next, at step 606, the call initiation request is forward to the advertiser using the mapped number.

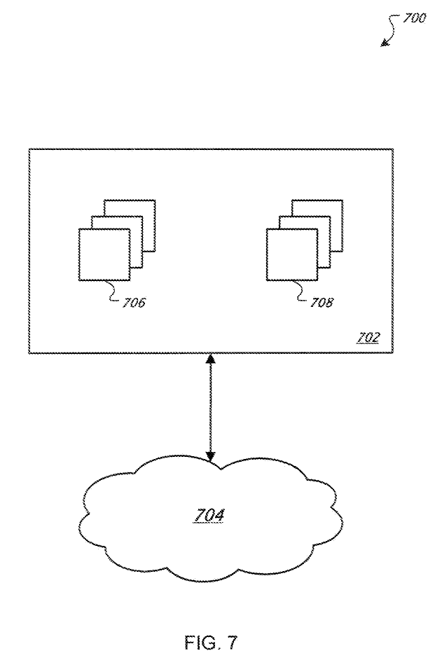

FIG. 7 is a block diagram illustrating an example system 700 for incorporating local telephone numbers with local TV ads. For example, the system 700 may include, ad, or otherwise incorporate numbers with area codes assigned to the geographic region where the local TV ads are broadcasted. The TV ads may be broadcasted wirelessly (e.g., satellite, UHF, VHF, IPTV) and/or via a wireline (e.g., cable, IPTV). In some implementations, the system 700 can incorporate the local telephone number in proximity to the display presenting the local TV ad.

In some implementations, the system 700 includes an ad element 702 coupled to a network 704. The ad element 702 comprises any software, hardware, and/or firmware operable to incorporate local telephone numbers with local TV ads. In some implementations, the ad element 702 comprises a set-top box connected to a display (not illustrated). In the illustrated implementation, the ad element 702 includes TV ads 706 and 708 local number files. The TV ads 706 include any parameters, pointers, variables, algorithms, instructions, rules, files, links, or other data for easily providing secondary content for through a display (e.g., television). Such TV ads 706 may include (among other things) primary content, secondary content, and/or sponsored content. For example, each TV ad 706 may include text elements, multimedia elements, and/or other elements.

The local number files 708 can include any parameters, variables, policies, algorithms, instructions, settings, rules, or directives for mapping local telephone numbers to TV ads 706. For example, the local number tile 708 may include a directive for mapping a telephone number assigned to a geographic region to a TV ad 706. In some implementations, the local number files 708 may include directives for one or more of the following: mapping a local number to a TV ad 706, defining attributes for the local number (e.g., text, font size, position), and/or incorporating the local phone number in the TV ad. The local number file 708 may be associated with a single TV ad 706 or multiple TV ads 706. In some implementations, the local number files 708 is generated and/or updated by an advertiser to identify geographic locations that are tracked. In some implementations, the system 700 receives a request from an advertiser identifying geographic locations associated with a TV ad 706 and generates and/or updates an associated local number file 708 based, at least in part, on the request. By receiving instructions from the advertiser, the advertiser may identify geographic locations of interests. In some implementations, the advertiser may request specific phone numbers for certain geographic locations. For example, an advertiser may request one phone number to cover zip code 12345 and a different number to cover 12346. In accordance with this type of request, the system 700 may generate one or more local number files 708. The local number file 708 may be stored in one or more tables stored in a relational database described in terms of SQL statements or scripts. In some implementations, the local number file 708 may be formatted, stored, or defined as various data structures in text files, XML documents, VSAM files, flat files, Btrieve files, CSV files, internal variables, or one or more libraries. In short, the local number file 708 may comprise one table or file or a plurality of tables or files stored on one computer or across a plurality of computers in any appropriate format. Moreover, the local number file 708 may be local or remote without departing from the scope of this disclosure and store any type of appropriate data.

While the illustrated implementation indicates that the system 700 incorporates a local number with an ad at a set-top box. The system 700 may execute this processes using any other suitable manner such as before the ad is broadcast. In this case, the ad may be combined with the local number by the advertiser, by an ad agency placing the ads, using broadcaster's equipment, or others.

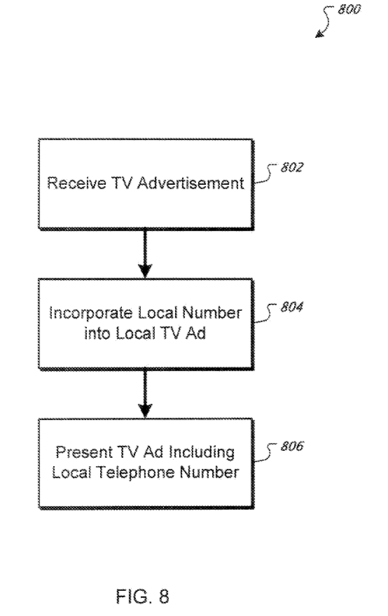

FIG. 8 is a flowchart illustrating example method 800 for incorporating a local TV ads with a local phone number. Method 800 generally describe using local telephone numbers for identifying tracking information using call Initiation requests. By way of example, methods 500 and 600 can be executed by system 100 using any appropriate combination and arrangement of logical elements implementing some or all of the described functionality.

Method 800 begins at step 802 where a TV ad for particular geographic region is received. At step 804, a local telephone number is incorporated into the local TV ad. For example, the ad element 702 can identify a phone number for the geographic region and add the local number to the TV ad. Next, at step 806, the local TV ad including the local telephone number is presented.

A number of embodiments of the invention have been described. Nevertheless, it will be understood that various modifications may be made without departing from the spirit and scope of the invention. Accordingly, other embodiments are within the scope of the following claims.

1. A computer-implemented method comprising:
receiving a request from an advertiser, wherein the request identifies (i) a plurality of geographic regions specified by the advertiser for which a TV advertisement is to be tracked, and (ii) different destination telephone number, specified by the advertiser, to be incorporated into the TV advertisement for each of the geographic regions;
identifying set top boxes associated with each of the geographic regions specified by the advertiser;
instructing each of a plurality of set top boxes in each of the geographic regions to incorporate the destination telephone number for the geographic region in which the set top box is located into the TV advertisement, wherein the instructing comprises:
providing telephone number-advertisement files to the plurality of set top boxes, the telephone number-advertisement files comprising mappings of destination telephone numbers for particular geographic regions to TV advertisements of different advertisers for use by the plurality of set top boxes to identify which destination telephone numbers to incorporate into which TV advertisements, wherein the telephone number-advertisement files include mappings for the plurality of geographic regions and destination telephone numbers specified by the advertiser in the request;
instructing a first set top box in a first geographic region to incorporate a first destination telephone number into the TV advertisement based at least in part on the telephone number-advertisement files; and
instructing a second set top box in a second geographic region to incorporate a second destination telephone number into the TV advertisement based at least in part on the telephone number-advertisement files;
for each of the destination telephone numbers, receiving at least one call initiation request directed to the destination telephone number;
associating each of the call initiation requests with one of the geographic regions based at least in part on associations between the geographic regions and the destination telephone numbers identified in the request from the advertiser;
identifying tracking information for the TV advertisement for each of the geographic regions from the call initiation requests;
determining metrics associated with the TV advertisement for each of the geographic regions using the tracking information; and
generating advertisement metrics data specifying at least one or more of the metrics for presentation to the advertiser.

2. The method of claim 1, wherein for each of the geographic regions, the destination telephone number for the geographic region is a telephone number within a local calling range to other telephone numbers in the geographic region.

3. The method of claim 2, further comprising:
in response to receiving at least one of the call initiation requests, mapping the destination telephone number to which the at least one of the call initiation requests is directed to a phone number associated with the advertiser; and
forwarding the at least one of the call initiation requests to the advertiser using the mapped phone number.

4. The method of claim 2, further comprising:
receiving the TV advertisement from the advertiser;
instructing each set top box to incorporate the destination telephone number for the geographic region in which the set top box is located into the TV advertisement at the set top box based at least in part on the telephone number-advertisement files; and
instructing each set top box to present the TV advertisement in the geographic region, the TV advertisement displaying the destination telephone number for the geographic region in which the set top box is located.

5. The method of claim 1, wherein the metrics comprise at least one of a total number of calls per geographic region or a total number of transactions per geographic region.

6. The method of claim 1, wherein at least a portion of the tracking information is obtained from an element in a public switched telephone network.

7. (canceled)

8. A computer-readable storage medium storing instructions which when executed by one or more data processing apparatuses cause the one or more data processing apparatuses to perform operations comprising:
receiving a request from an advertiser, wherein the request identifies (i) a plurality of geographic regions specified by the advertiser for which a TV advertisement is to be tracked, and (ii) a different destination telephone number specified by the advertiser to be incorporated into the TV advertisement for each of the geographic regions;
identifying set top boxes associated with each of the geographic regions specified by the advertiser;
instructing each of a plurality of set top boxes in each of the geographic regions to incorporate the destination telephone number for the geographic region in which the set top box is located into the TV advertisement, wherein the instructing comprises:
providing telephone number-advertisement files to the plurality of set top boxes, the telephone number-advertisement files comprising mappings of destination telephone numbers for particular geographic regions to TV advertisements of different advertisers for use by the plurality of set top boxes to identify which destination telephone numbers to incorporate into which TV advertisements, wherein the telephone number-advertisement files include mappings for the plurality of geographic regions and destination telephone numbers specified by the advertiser in the request;
instructing a first set top box in a first geographic region to incorporate a first destination telephone number into the TV advertisement based at least in part on the telephone number-advertisement files; and
instructing a second set top box in a second geographic region to incorporate a second destination telephone number into the TV advertisement based at least in part on the telephone number-advertisement files;
for each of the destination telephone numbers, receiving at least one call initiation request directed to the destination telephone number;
associating each of the call initiation requests with one of the geographic regions based at least in part on associations between the geographic regions and the destination telephone numbers identified in the request from the advertiser;
identifying tracking information for the TV advertisement for each of the geographic regions from the call initiation requests;
determining metrics associated with the TV advertisement for each of the geographic regions using the tracking information; and
generating advertisement metrics data specifying at least one or more of the metrics for presentation to the advertiser.

9. The computer-readable storage medium of claim 8, wherein for each of the geographic regions, the destination telephone number for the geographic region is a telephone number within a local calling range to other telephone numbers in the particular geographic region.

10. The computer-readable storage medium of claim 9, wherein the operations further comprise:
in response to receiving at least one of the call initiation requests, mapping the destination telephone number to which the at least one of the call initiation requests is directed to a phone number associated with the advertiser; and
forwarding the at least one of the call initiation requests to the advertiser using the mapped phone number.

11. The computer-readable storage medium of claim 9 wherein the operations further comprise:
receiving the TV advertisement from the advertiser;
instructing each set top box to incorporate the destination telephone number for the geographic region in which the set top box is located into the TV advertisement at the set top box based at least in part on the telephone number-advertisement files; and
instructing each set top box to present the TV advertisement in the geographic region, the TV advertisement displaying the destination telephone number for the geographic region in which the set top box is located.

12. The computer-readable storage medium of claim 8, wherein the metrics comprise at least one of a total number of calls per geographic region or a total number of transactions per geographic region.

13. The computer-readable storage medium of claim 8, wherein at least a portion of the tracking information is obtained from an element in a public switched telephone network.

14. (canceled)

15. A system, comprising one or more processors and memory coupled to the one or more processors and including instructions, which, when executed by the one or more processors, cause the one or more processors to perform operations comprising:
receiving a request from an advertiser, wherein the request identifies (i) a plurality of geographic regions specified by the advertiser for which a TV advertisement is to be tracked, and (ii) a different destination telephone number, specified by the advertiser, to be incorporated into the TV advertisement for each of the geographic regions;
instructing each of a plurality of set top boxes in each of the geographic regions to incorporate the destination telephone number for the geographic region in which the set top box is located into the TV advertisement, wherein the instructing comprises:
providing telephone number-advertisement files to the plurality of set top boxes, the telephone number-advertisement files comprising mappings of destination telephone numbers for particular geographic regions to TV advertisements of different advertisers for use by the plurality of set top boxes to identify which destination telephone numbers to incorporate into which TV advertisements, wherein the telephone number-advertisement files include mappings for the plurality of geographic regions and destination telephone numbers specified by the advertiser in the request;
instructing a first set top box in a first geographic region to incorporate a first destination telephone number into the TV advertisement based at least in part on the telephone number-advertisement files; and
instructing a second set top box in a second geographic region to incorporate a second destination telephone number into the TV advertisement based at least in part on the telephone number-advertisement files;
for each of the destination telephone numbers, receiving at least one call initiation request directed to the destination telephone number;
associating each of the call initiation requests with one of the geographic regions based at least in part on associations between the geographic regions and the destination telephone numbers identified in the request from the advertiser;
identifying tracking information for the TV advertisement for each of the geographic regions from the call initiation requests;
determining metrics associated with the TV advertisement for each of the geographic regions using the tracking information; and
generating advertisement metrics data specifying at least one or more of the metrics for presentation to the advertiser.

16. The system of claim 15, wherein for each of the geographic regions, the destination telephone number for the geographic region is a telephone number within a local calling range to other telephone numbers in the geographic region.

17. The system of claim 16, wherein the operations further comprise:
in response to receiving at least one of the call initiation requests, mapping the destination telephone number to which the at least one of the call initiation requests is directed to a phone number associated with the advertiser; and
forwarding the at least one of the call initiation requests to the advertiser using the mapped phone number.

18. The system of claim 16, wherein the operations further comprise:
receiving the TV advertisement from the advertiser;
instructing each set top box to incorporate the destination telephone number for the geographic region in which the set top box is located into the TV advertisement at the set top box based at least in part on the telephone number-advertisement files; and
instructing each set top box to present the TV advertisement in the geographic region, the TV advertisement displaying the destination telephone number for the geographic region in which the set top box is located.

19. The system of claim 15, the metrics comprising at least one of a total number of calls per geographic region or a total number of transactions per geographic region.

20. The system of claim 15, wherein at least a portion of the tracking information is obtained from an element in a public switched telephone network.

21-27. (canceled)

28. The method of claim 1, wherein instructing set top boxes comprises providing display attribute data to the set top boxes specifying at least one of a text type, font size and position for a display of a destination telephone number with the TV advertisement.

29. The method of claim 1, further comprising:
receiving a second request from a second advertiser, wherein the second request identifies (i) one of the geographic regions as a geographic region for which a second TV advertisement for the second advertiser is to be tracked, and (ii) a second destination telephone number to be incorporated into the second TV advertisement for the one of the geographic regions; and
wherein instructing set top boxes in each of the geographic regions comprises instructing the set top boxes in the one of the geographic regions to incorporate the second destination telephone number into the second TV advertisement based at least in part on the telephone number-advertisement files.

30. The method of claim 1, wherein associating each of the call initiation requests with one of the geographic regions comprises:
associating a particular one of the call initiation requests with a particular one of the geographic regions in response to a determination that a destination telephone number to which the particular one of the call initiation request was directed is associated with the particular one of the geographic regions in the request.
